(19) United States
(12) Patent Application Publication
(10) Pub. No.: US 2024/0028411 A1
(43) Pub. Date: Jan. 25, 2024

(54) CLUSTER ADD-ON LIFECYCLE MANAGEMENT

(71) Applicant: VMware, Inc., Palo Alto, CA (US)

(72) Inventors: Hailing XU, Beijing (CN); Liang CUI, Beijing (CN); Aravind SRINIVASAN, Sunnyvale, CA (US); Ni LU, Beijing (CN)

(73) Assignee: VMware, Inc., Palo Alto, CA (US)

(21) Appl. No.: 17/940,004

(22) Filed: Sep. 8, 2022

(30) Foreign Application Priority Data
Jul. 21, 2022 (WO) PCT/CN2022/106927

(51) Int. Cl. G06F 9/50

(52) U.S. Cl. CPC G06F 9/5055; G06F 9/5072; G06F 2209/505; G06F 2209/508

(57) ABSTRACT

Example methods and systems for cluster add-on lifecycle management are described. In one example, a computer system may obtain cluster add-on definition information specifying multiple add-ons that are each capable of extending functionality of at least a first cluster and a second cluster. User interface(s) may be generated based on the cluster add-on definition information to allow a user to request for a management action associated. In response to receiving a first request for a first management action associated with the first add-on, a first instruction may be generated and sent to cause the first management action to be performed in the first cluster. In response to receiving a second request for a second management action associated with the second add-on, a second instruction may be generated and sent to cause the second management action to be performed in the first cluster or the second cluster.

### CROSS REFERENCE TO RELATED APPLICATIONS

The present application claims the benefit of Patent Cooperation Treat (PCT) Application No. PCT/CN2022/106927, filed Jul. 21, 2022. The present application is also related in subject matter to Patent Application Ser. No. ______ (Attorney Docket No. 1133.02). The PCT application and the related US application are incorporated herein by reference.

### BACKGROUND

As defined by the Cloud Native Computing Foundation (CNCF), cloud-native technologies empower organizations to build and run scalable applications in modern, dynamic environments such as public, private and hybrid clouds. In practice, cloud-native applications may rely on microservice- and container-based architectures. For example, a cloud-native application may include multiple services (known as microservices) that run independently in self-contained, lightweight containers. The Kubernetes® microservices system by The Linux Foundation® has risen in popularity in recent years as a substantially easy way to support, scale and manage cloud-native applications deployed in clusters. In practice, it may be desirable to extend functionality of such clusters through cluster add-ons.

### BRIEF DESCRIPTION OF DRAWINGS

FIG. 1 is a schematic diagram illustrating an example network environment in which cluster add-on lifecycle management may be performed;

FIG. 2 is a flowchart of an example process for a computer system capable of implementing a management entity to perform cluster add-on lifecycle management;

FIG. 3 is a flowchart of an example process for a computer system capable of implementing a cluster operator to perform cluster add-on lifecycle management;

FIG. 4 is a schematic diagram illustrating an example format of cluster add-on definition information;

FIG. 5 is a schematic diagram illustrating a first example of cluster add-on definition information specifying multiple add-ons;

FIG. 6 is a schematic diagram illustrating first example user interfaces for cluster add-on lifecycle management;

FIG. 7 is a schematic diagram illustrating a second example of cluster add-on definition information specifying multiple add-ons;

FIG. 8 is a schematic diagram illustrating second example user interfaces for cluster add-on lifecycle management;

FIG. 9 is a flowchart of an example detailed process for management cluster creation and core add-on installation based on cluster add-on definition information;

FIG. 10 is a flowchart of an example detailed process for workload cluster creation and core add-on installation based on cluster add-on definition information;

FIG. 11 is a flowchart of an example detailed process for service add-on installation based on cluster add-on definition information and uninstallation;

FIG. 12 is a schematic diagram illustrating example custom resource (CR) with secret definition for service add-on installation;

FIG. 13 is a flowchart of an example detailed process for cluster add-on update based on cluster add-on definition information;

FIG. 14 is a flowchart of an example detailed process for cluster add-on upgrade based on cluster add-on definition information;

FIG. 15 is a flowchart of an example detailed process for cluster add-on status monitoring based on cluster add-on definition information;

FIG. 16 is a schematic diagram illustrating example cluster add-on definition information and user interface for cluster add-on status monitoring; and

FIG. 17 is a schematic diagram illustrating an example software-defined networking (SDN) environment in which cluster add-on lifecycle management may be performed.

### DETAILED DESCRIPTION

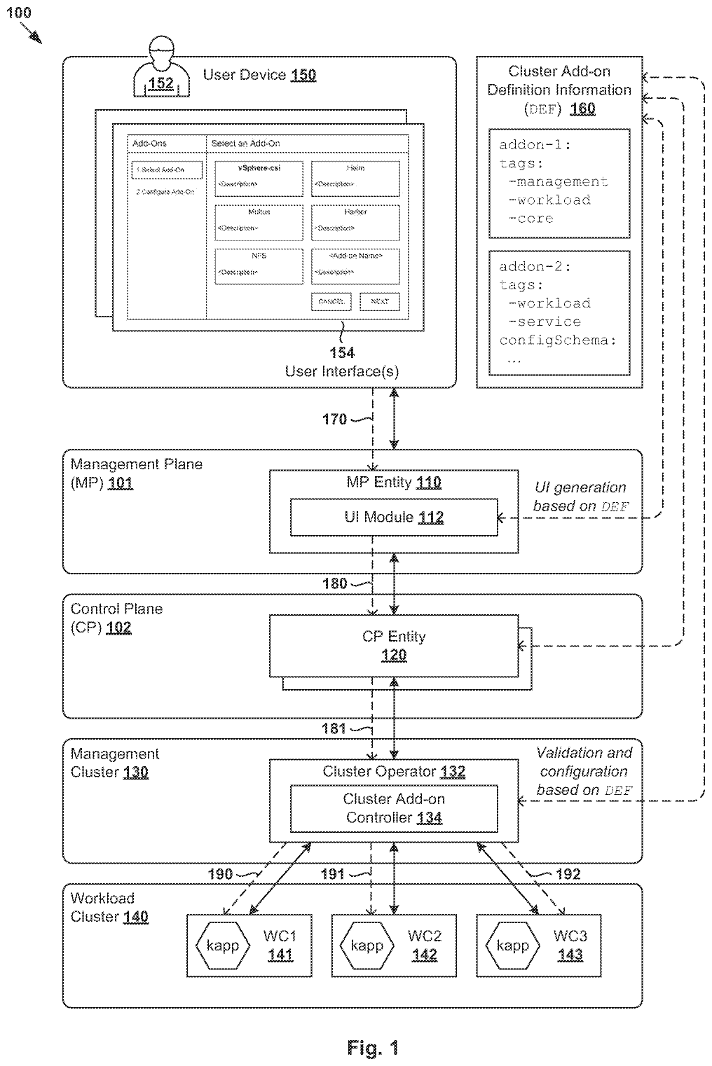

According to a first aspect, examples of the present disclosure provide a computer system capable of implementing a management entity (e.g., management plane (MP) entity 110 in FIG. 1) to perform cluster add-on lifecycle management. In one example, the management entity may obtain cluster add-on definition information (see 160 in FIG. 1) specifying multiple add-ons that are each capable of extending functionality of at least a first cluster and a second cluster. The multiple add-ons include a first add-on associated with multiple first configuration fields and a second add-on associated with multiple second configuration fields. The management entity may generate user interface(s) based on the cluster add-on definition information to allow a user to request for a management action associated with at least one of the multiple cluster add-ons (see 150 in FIG. 1).

In response to receiving a first request for a first management action associated with the first add-on via a first user interface, a first instruction may be generated and sent to cause the first management action to be performed in the first cluster based on multiple first configuration values associated with the respective multiple first configuration fields. In response to receiving a second request for a second management action associated with the second add-on via a second user interface, a second instruction may be generated and sent to cause the second management action to be performed in the first cluster or the second cluster based on multiple second configuration values associated with the respective multiple second configuration fields. See 170 and 180/181 in FIG. 1.

According to a second aspect, examples of the present disclosure provide a computer system capable of implementing as a cluster operator (e.g., operator 132 deployed in management cluster 130 in FIG. 1) to perform cluster add-on lifecycle management. In one example, the cluster operator may obtain cluster add-on definition information specifying multiple add-ons that are each capable of extending functionality of at least a first cluster and a second cluster. The multiple add-ons include a first add-on associated with multiple first configuration fields and a second add-on associated with multiple second configuration fields. See 160 in FIG. 1.

In response to receiving a first instruction to perform a first management action associated with the first add-on in the first cluster, a first validation operation may be performed based on the cluster add-on definition information and multiple first configuration values associated the multiple first configuration fields. The first management action may be performed in the first cluster in response to determination that the first validation operation is successful. In response to receiving a second instruction to perform a second management action associated with the second add-on in the second cluster, a second validation operation may be performed based on the cluster add-on definition information and multiple second configuration values associated the multiple second configuration fields. The second management action may be performed in the second cluster in response to determination that the second validation operation is successful. See 180/181 and 190/191/192 in FIG. 1.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used to describe various elements, these elements should not be limited by these terms. These terms are used to distinguish one element from another. For example, a first element may be referred to as a second element, and vice versa.

In more detail, FIG. 1 is a schematic diagram illustrating example network environment 100 in which cluster add-on lifecycle management may be performed. Depending on the desired implementation, network environment 100 may include additional and/or alternative component(s) than that shown in FIG. 1. Here, network environment 100 may include various management entities, such as management plane (MP) entity 110 residing on MP 101 and multiple control plane (CP) entities 120 (one shown for simplicity) on CP 102. MP entity 110 and CP entities 120 may be deployed to manage various clusters, such as management cluster 130 (one shown for simplicity) and workload clusters 141-143. For example, three example workload clusters with respective namespaces WC1 141, WC2 142 and WC3 143 are shown in FIG. 1. Workload clusters 141-143 will be collectively referred to as 140.

Any suitable technology may be implemented in network environment 100, such as VMware® Telco Cloud Automation (TCA), etc. Using TCA as an example, MP entity 110=TCA-M and CP entity 120=TCA-CP may be deployed to facilitate multi-cloud operational management, etc. In practice, TCA may be implemented to provide orchestration and management services for Telco clouds. TCA-M and TCA-CP may provide infrastructure abstraction for placing workloads across clouds, and support any suitable virtual infrastructure manager (VIM) types, such as VMware vSphere®, VMware Cloud Director®, OpenStack, Kubernetes, etc. In practice, multiple TCA-CPs may be deployed in different geographical locations and/or associated with different versions supported by TCA-M. Each TCA-CP may be configured to validate and translate configuration instructions from TCA-M to down-layer components (e.g., cluster operator 132) that are capable of booting and customizing clusters, etc.

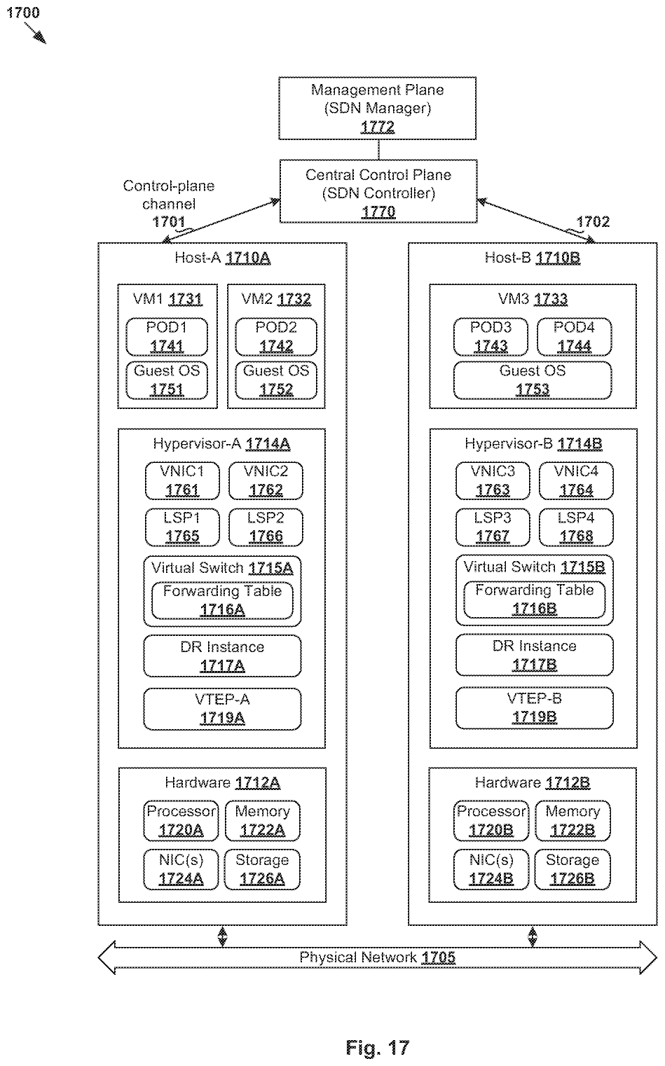

Through MP entity 110 and/or CP entity 120, user 152 operating user device 150 may manage various clusters 130-140, such as Kubernetes cluster(s) that are deployed in container-based network environment 100, etc. In practice, the term “cluster” may refer generally to a set of nodes for running containerized application(s). The term “container” is used generally to describe an application that is encapsulated with all its dependencies (e.g., binaries, libraries, etc.). For example, multiple containers may be executed as isolated processes inside a virtual machine (VM). Each “OS-less” container does not include any OS that could weigh 10s of Gigabytes (GB). This makes containers more lightweight, portable, efficient and suitable for delivery into an isolated OS environment. A pod may refer generally to a set of one or more containers sharing networking and storage resources from the same node. Example VMs, containers and pods will be explained using FIG. 17.

Depending on the desired implementation, MP entity 110 may provide user interfaces (UIs) and Representational State Transfer (REST) application programming interfaces (APIs) to user 152 (e.g., network administrator) to automate virtual infrastructure deployment, provision Kubernetes cluster(s), manage cluster-dependent virtual infrastructure and third-party systems, customize cluster node(s), instantiate service(s), etc. This way, MP entity 110 may provide a centralized lifecycle management interface to user 152.

In the example in FIG. 1, two example cluster types are shown. Management cluster 130 may be deployed to manage workload clusters 140 and packaged services. Workload clusters 140 may be deployed by management cluster 130 to run containerized workloads. Here, the term “workload” may refer generally to an application running on a cluster of nodes. Depending on the needs of various applications, workload clusters 140 may run different Kubernetes versions. Any suitable cluster lifecycle management system(s) may be implemented to manage cluster 130/140, such as VMware® Tanzu Kubernetes Grid (TKG) that facilitates cluster deployment across software-defined data centers (SDDC) and public cloud environments, etc.

In practice, cloud-native applications may depend on services provided by Kubernetes cluster add-ons, such as container network interface (CNI), container storage interface (CSI), Harbor client by the Linux® Foundation, load balancer, etc. Using the TCA example again, cluster add-ons may be installed to support various telco virtualized network functions (VNFs), such as to provide cluster node customization, multiple interfaces, etc. Conventionally, the delivery model for cluster add-ons may be inefficient and requires substantial hard coding in some cases. As more and more cluster add-ons are required by management cluster 130 and/or workload clusters 140, it may be increasingly complex to deploy and manage those cluster add-ons.

Cluster Add-on Lifecycle Management

According to examples of the present disclosure, lifecycle management of cluster add-ons may be performed in a more efficient manner. Depending on the desired implementation, examples of the present disclosure may be implemented as part of a unified cluster add-on lifecycle management framework across various cluster add-ons (e.g., core/service add-ons in various categories), cluster types (e.g., management and/or workload clusters) and Kubernetes versions. For example, the lifecycle management framework may support various management actions associated with cluster add-on lifecycle management, such as installation, uninstallation, configuration update, upgrade and status monitoring.

Using examples of the present disclosure, cluster add-on definition information (see 160 in FIG. 1) may be leveraged to facilitate end-to-end cluster add-on lifecycle management. In practice, examples of the present disclosure may be implemented to provide a unified add-on consumption model where the cluster add-on definition information may be modified incrementally to support new add-on(s), or add-on configuration field(s), with substantially minimal or no modification to UI module 112, CP entity 120 and cluster operator 132. This improves the efficiency of the delivery model for cluster add-ons.

(a) Management Entity

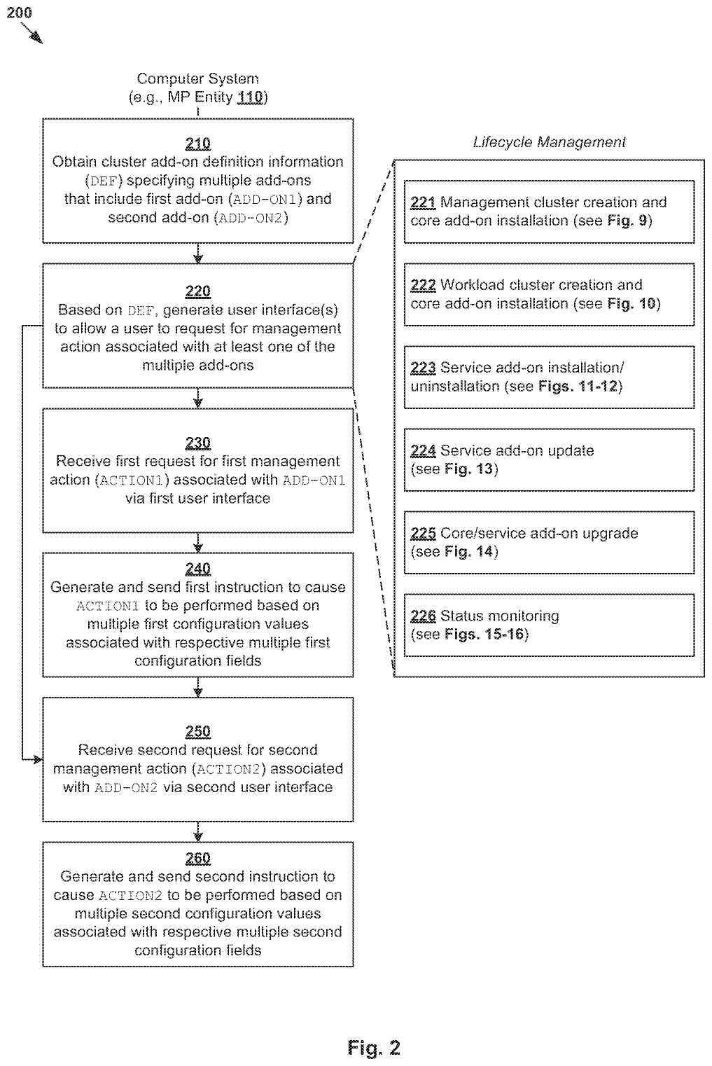

According to a first aspect of the present disclosure, a computer system may be configured to implement a management entity (e.g., MP entity 110) to perform cluster add-on lifecycle management. In more detail, FIG. 2 is a flowchart of example process 200 for a computer system capable of implementing a management entity to perform cluster add-on lifecycle management. Example process 200 may include one or more operations, functions, or actions illustrated by one or more blocks, such as 210 to 260. Depending on the desired implementation, various blocks may be combined into fewer blocks, divided into additional blocks, and/or eliminated.

At 210 in FIG. 2, MP entity 110 may obtain cluster add-on definition information (see 160 in FIG. 1) specifying multiple add-ons that are each capable of extending functionality of at least a first cluster and a second cluster. Here, the term “obtain” may refer generally to cluster operator 132 receiving or retrieving cluster add-on definition information from any suitable source or datastore. The multiple add-ons may include at least a first add-on associated with multiple first configuration fields and a second add-on associated with multiple second configuration fields.

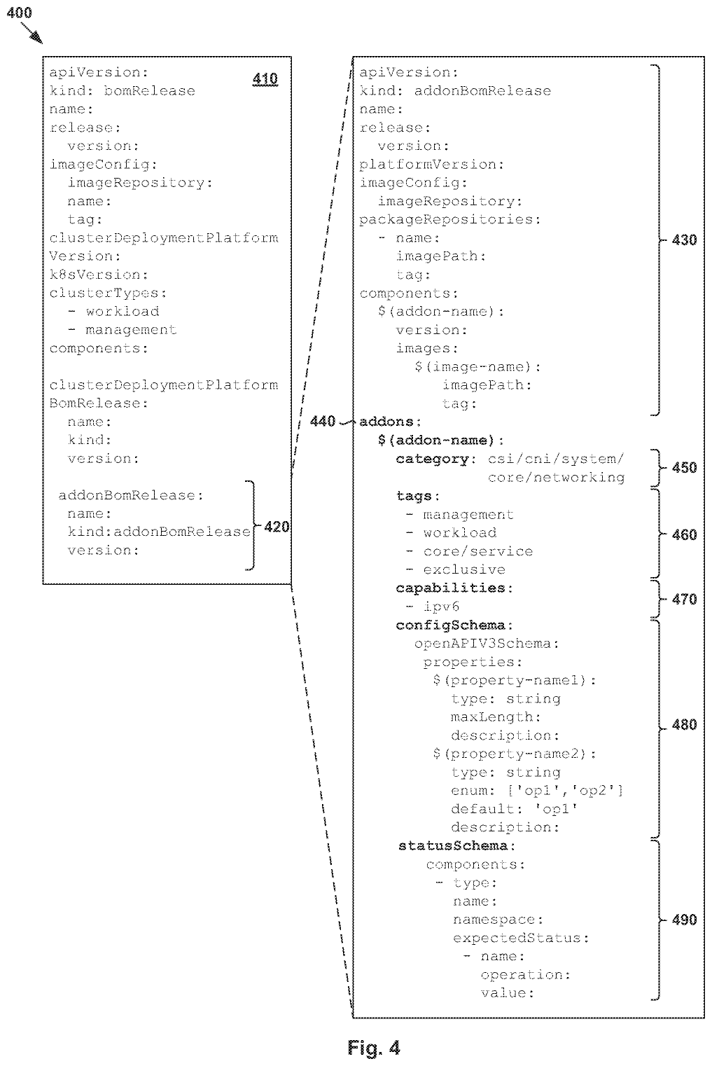

Throughout the present disclosure, the term “cluster add-on definition information” may refer generally to any suitable information specifying multiple cluster add-ons that are installable to extend the functionality of cluster(s). The term “cluster add-on” may refer generally to a set of feature(s) for extending the functionality or capability of a cluster. A cluster add-on may be a core add-on or service add-on. A core add-on is generally installed by default when a corresponding cluster is created (and uninstalled when the cluster is deleted). A service add-on is generally installed on demand to provide additional functionalities that are not installed by default. As will be exemplified using FIGS. 4-8, each add-on may be associated with any suitable configuration field(s).

Using the example in FIG. 1, a first add-on (e.g., “addon-1”) may be a core add-on that is installable to extend the functionality of management cluster 130 or workload cluster 140 (e.g., see tags=“management,” “workload” and “core”). A second add-on (e.g., “addon-2”) may be a service add-on that is installable to extend the functionality of workload cluster 140 (e.g., see tags=“workload” and “service”). Cluster add-on definition information 160 may specify multiple add-ons associated with different add-on types, cluster types, Kubernetes version, etc.

At 220 in FIG. 2, MP entity 110 may generate UI(s) based on the cluster add-on definition information to allow a user to request for a management action associated with at least one of the multiple cluster add-ons. In the example in FIG. 1, MP entity 110 (e.g., using UI module 112) may generate UI(s) 154 based on cluster add-on definition information 160, such as to allow selection of at least one cluster add-on and apply a management action. UI(s) 154 may be provided to user 152 via user device 150. As will be described further below, a particular UI that includes multiple UI elements may be generated based on configuration schema information (see “configSchema” in FIG. 1) in cluster add-on definition information 160.

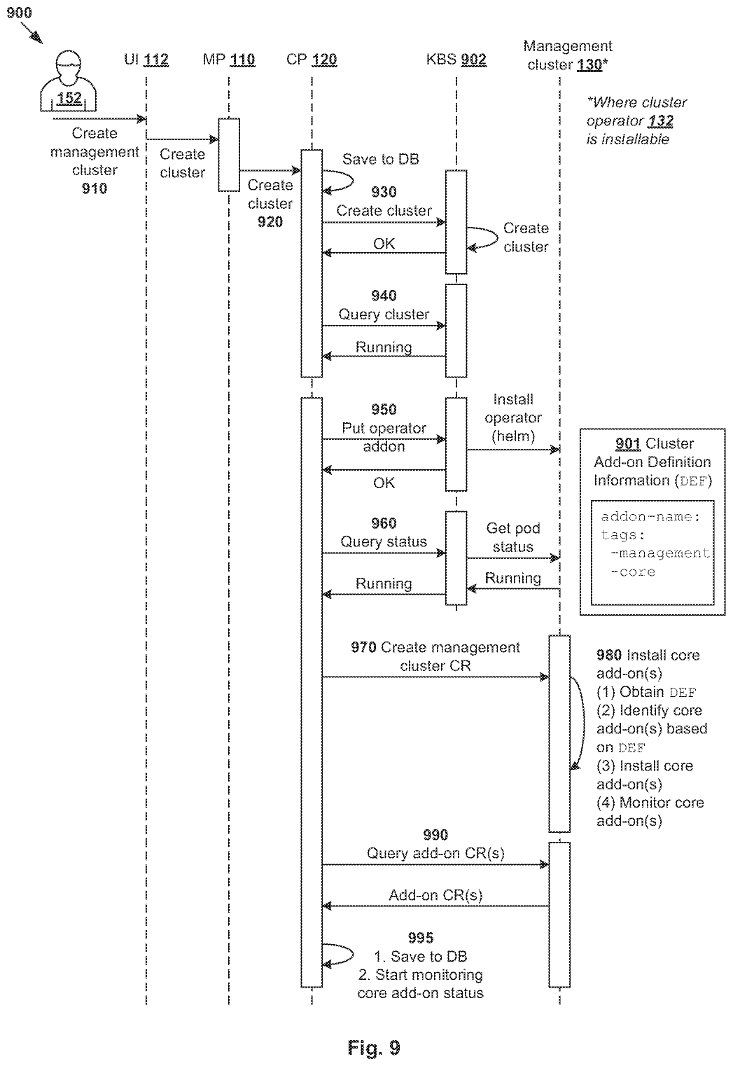

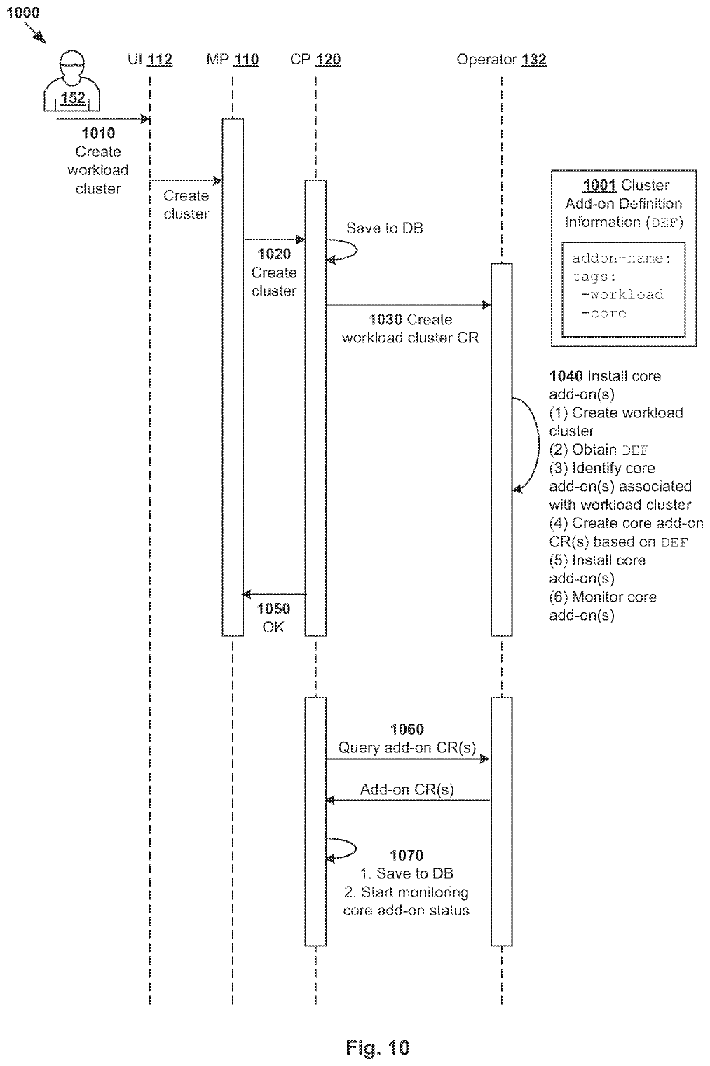

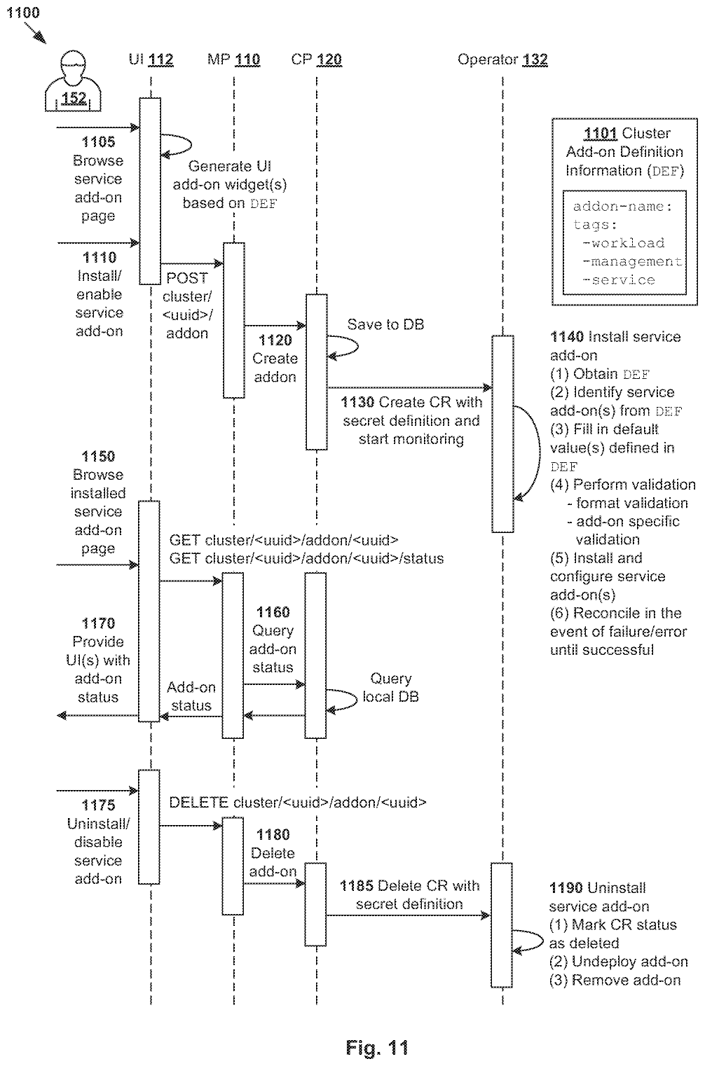

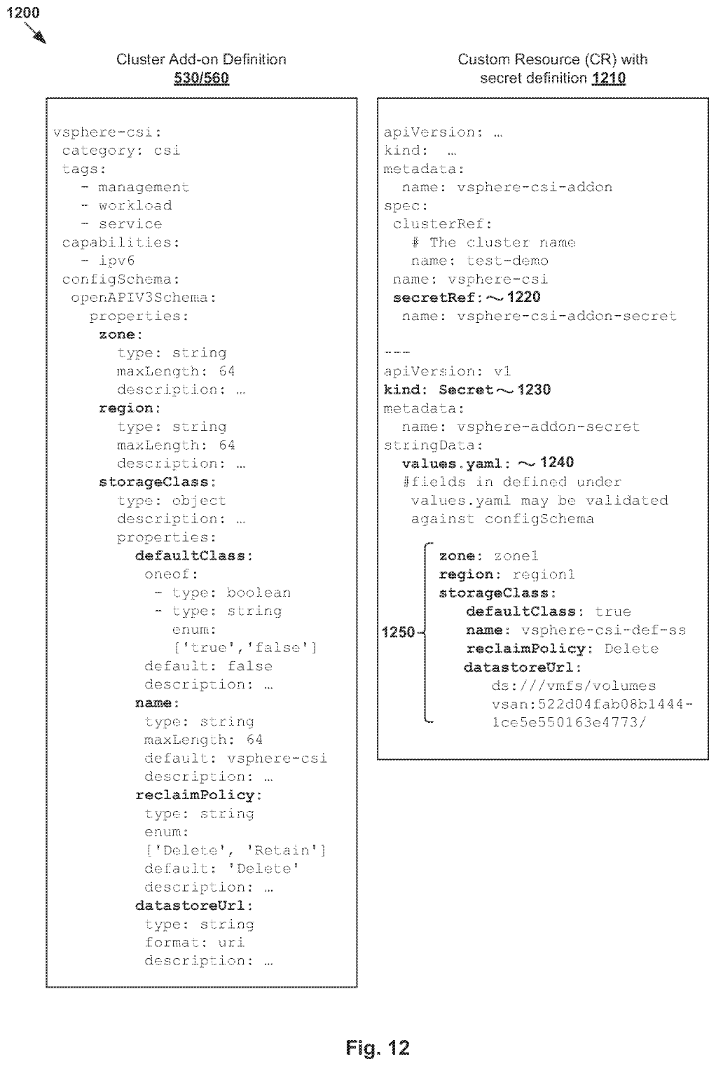

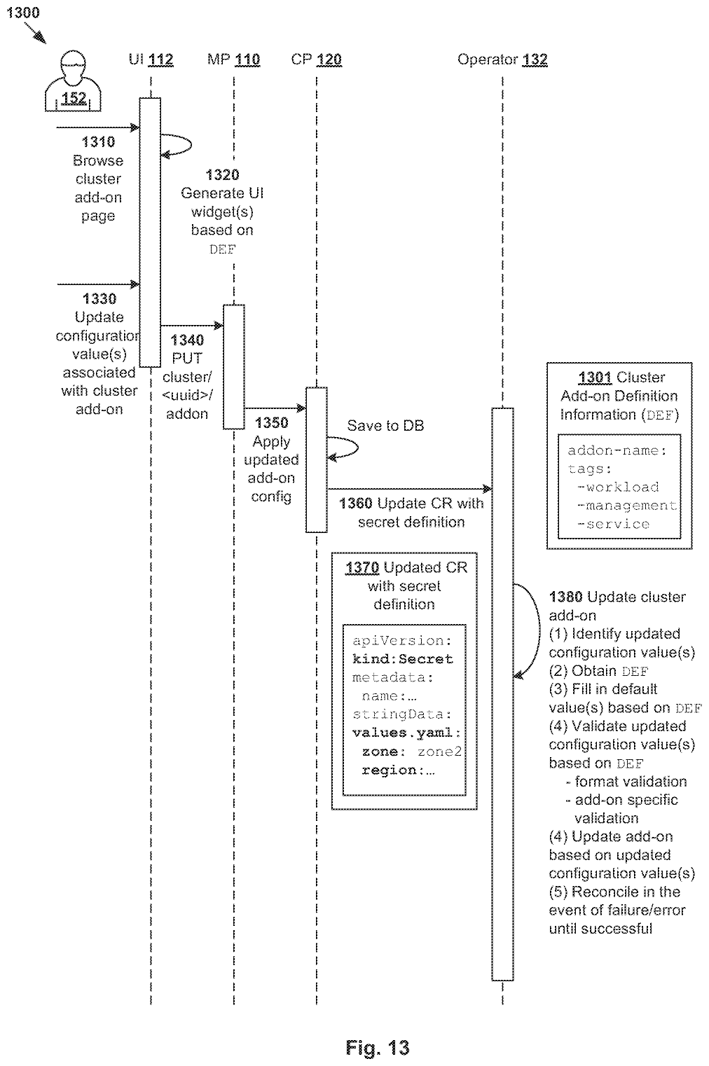

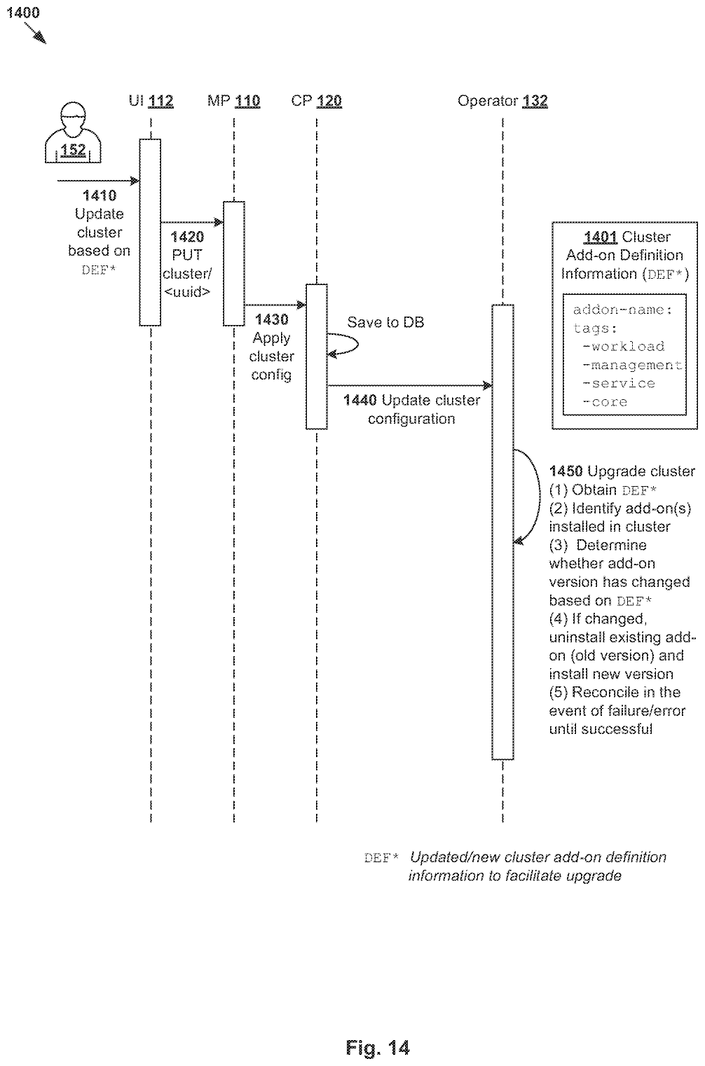

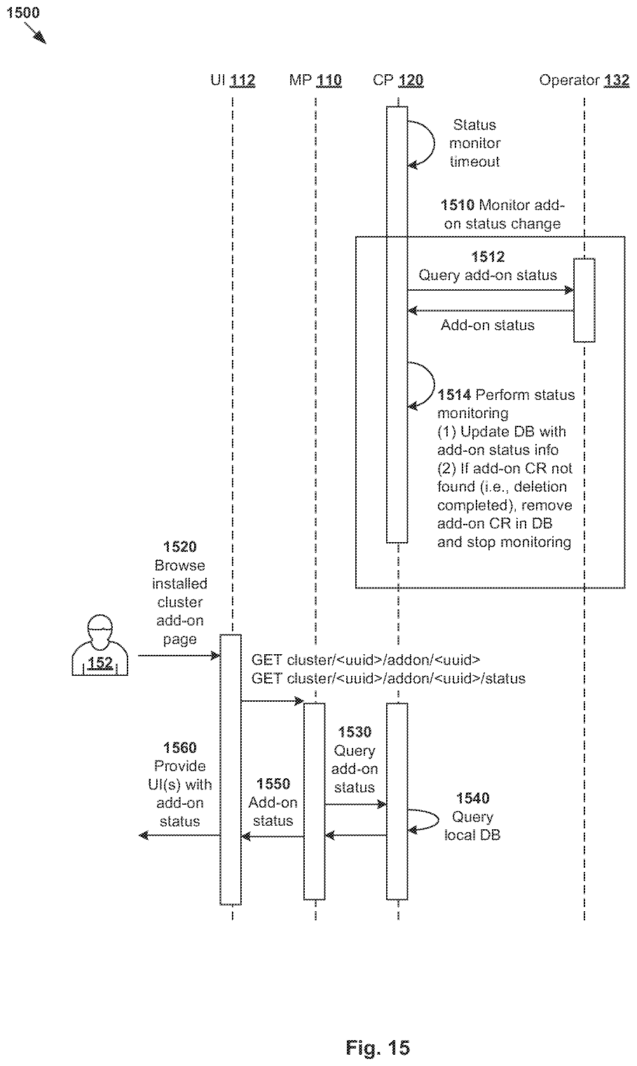

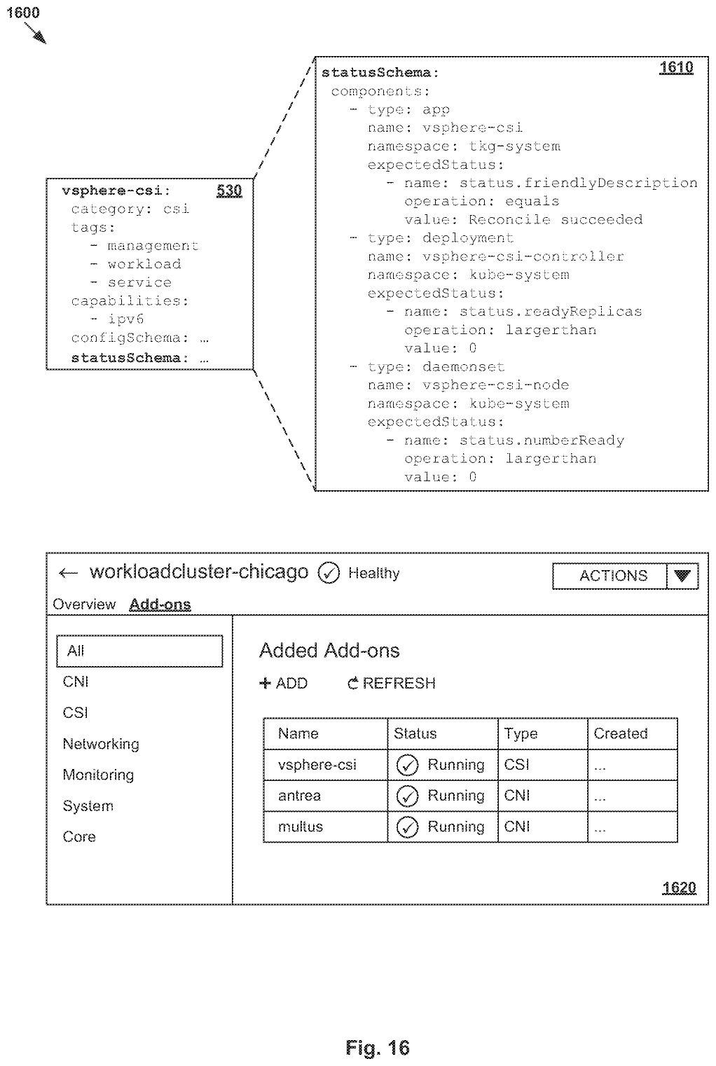

The UI(s) may be generated to allow user 152 to request for any suitable management action(s) associated with cluster add-on lifecycle management. Various examples are shown in FIG. 2, including (a) management cluster creation and core add-on installation (see 221 and FIG. 9), (b) workload cluster creation and core add-on installation (see 222 and FIG. 10), (c) service add-on installation or uninstallation (see 223 and FIGS. 11-12), (d) service add-on configuration update (see 224 and FIG. 13), (e) service add-on upgrade (see 225 and FIG. 14), and (f) core add-on or service add-on status monitoring (see 226 and FIGS. 15-16).

At 230-240 in FIG. 2, in response to receiving a first request for a first management action associated with the first add-on via a first UI, a first instruction may be generated and sent to cause the first management action to be performed in the first cluster based on multiple first configuration values associated with the respective multiple first configuration fields. At 250-260, in response to receiving a second request for a second management action associated with the second add-on via a second UI, a second instruction may be generated and sent to cause the second management action to be performed in the first cluster or the second cluster based on multiple second configuration values associated with the respective multiple second configuration fields. See 170 (request) and 180-181 (instruction).

In the example in FIG. 1, block 240 may involve generating and sending the first instruction to perform the first management action in the form of creating the first cluster and installing the first add-on (e.g., core add-on) in management cluster 130. In the example in FIG. 1, block 260 may involve generating and sending the second instruction to perform the second management action in the form of installing, updating or upgrading the second add-on (e.g., service add-on) in workload cluster 140. The first/second instruction may be sent from MP entity 110 to CP entity 120 that is capable of instructing cluster operator 132 to perform the first/second management action (see also 190-192 in FIG. 9).

(b) Cluster Operator

According to a second aspect of the present disclosure, a computer system may be configured to implement cluster operator 132 in management cluster 130 to perform cluster add-on lifecycle management. As used herein, the term “cluster operator” may refer generally to any suitable entity or controller that is capable of implementing lifecycle management actions associated with a cluster, which may be a management cluster or workload cluster in the examples below. Depending on the desired implementation, cluster operator 132 may include add-on controller 134 (also known as add-on manager). Alternatively, add-on controller 134 may be an entity that is separate (i.e., decoupled) from cluster operator 132. In practice, since cluster operator 132 runs on management cluster 130, it may share the same fate as management cluster 130. Add-on controller 134 may be configured to manage both management cluster 130 and workload cluster 140. The term “cluster operator” may refer to an entity capable of implementing functionalities of entities 132 and/or 134. In the case of TCA, cluster operator 132 may be known as “tca-kubecluster-operator.”

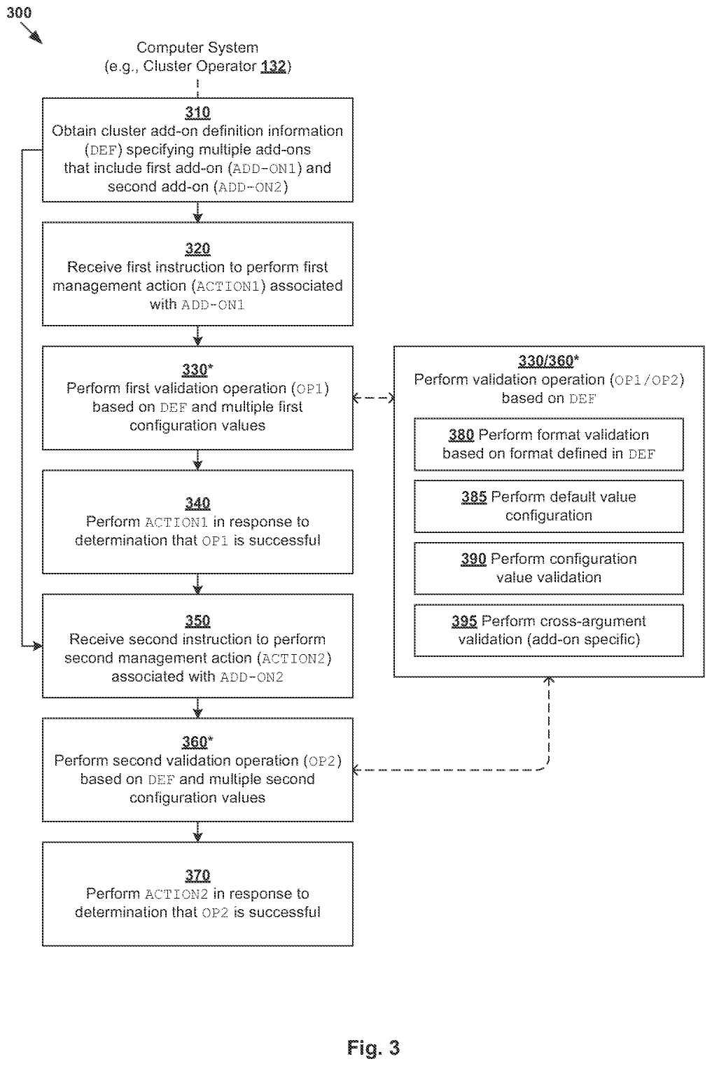

In more detail, FIG. 3 is a flowchart of example process 300 for a computer system capable of implementing cluster operator 132 to perform cluster add-on lifecycle management. Example process 300 may include one or more operations, functions, or actions illustrated by one or more blocks, such as 310 to 370. Depending on the desired implementation, various blocks may be combined into fewer blocks, divided into additional blocks, and/or eliminated.

At 310 in FIG. 3, cluster operator 132 may obtain cluster add-on definition information (see 160 in FIG. 1) specifying multiple add-ons that are each capable of extending functionality of at least a first cluster and a second cluster. The multiple add-ons include a first add-on associated with multiple first configuration fields and a second add-on associated with multiple second configuration fields. Here, the term “obtain” may refer generally to cluster operator 132 receiving or retrieving cluster add-on definition information from any suitable source or datastore.

Using the example in FIG. 1, a first add-on (e.g., “addon-1”) may be a core add-on that is installable to extend the functionality of management cluster 130 or workload cluster 140 (e.g., see tags=“management,” “workload” and “core”). A second add-on (e.g., “addon-2”) may be a service add-on that is installable to extend the functionality of workload cluster 140 (e.g., see tags=“workload” and “service”). Cluster add-on definition information 160 may specify multiple add-ons associated with different add-on types, cluster types, Kubernetes version, etc.

At 320-330 in FIG. 3, in response to receiving a first instruction to perform a first management action associated with the first add-on in the first cluster, a first validation operation may be performed based on the cluster add-on definition information and multiple first configuration values associated the multiple first configuration fields. The first management action may be performed in the first cluster in response to determination that the first validation operation is successful. In the example in FIG. 1, the first validation operation may be performed during cluster add-on installation in management cluster 130 or workload cluster 140.

At 350-370 in FIG. 3, in response to receiving a second instruction to perform a second management action associated with the second add-on in the second cluster, a second validation operation may be performed based on the cluster add-on definition information and multiple second configuration values associated the multiple second configuration fields. The second management action may be performed in the second cluster in response to determination that the second validation operation is successful. In the example in FIG. 1, the second validation operation may be performed during cluster add-on update or upgrade in management cluster 130 or workload cluster 140.

Depending on the desired implementation, any suitable validation operation may be performed. For example, block 330/360 may involve performing one or more of the following: (a) format validation to determine whether a particular configuration value is in a valid format specified by the cluster add-on definition information, (b) configuration value validation to determine whether a particular configuration value is valid and (c) cross-argument validation to determine a dependency between at least two configuration values. Prior to performing the validation operation (e.g., as a setup), default value configuration may be performed to configure one or more default configuration values associated with the first add-on or second add-on,

According to examples of the present disclosure, cluster add-on lifecycle management may be performed based on cluster add-on definition information 160, which allows different add-ons to be managed in an agnostic manner. This way, various layers or planes in network environment 100 may interpret cluster add-on definition information 160 to handle configuration/logic differences across add-on types, cluster types and Kubernetes versions. In practice, code for processing and parsing cluster add-on definition information 160 may be reused as cluster add-ons are added/removed. This reduces the likelihood of having to perform hard coding to handle those differences, which is inefficient. Various examples will be described using FIGS. 4-17 below.

Cluster Add-on Definition Information

According to examples of the present disclosure, cluster add-on definition information 160 may be configured to define the capability of cluster(s) and cluster add-on(s) for a certain Kubernetes version. Cluster add-on definition information 160 may be configured to specify configuration information associated with cluster creation or upgrade, as well as cluster add-on installation, configuration update or upgrade, etc. In practice, cluster add-on definition information 160 may be in any suitable format, such as static bill of materials (BOM) file(s) in YAML Ain′t Markup Language (YAML) format using human-readable data-serialization language in FIG. 4, etc.

(a) Example Format/Template

In more detail, FIG. 4 is a schematic diagram illustrating example format 400 of cluster add-on definition information. At 410, cluster add-on definition information 160 may include configuration fields to define version information (e.g., API version, Kubernetes version, cluster deployment platform version), applicable cluster types (e.g., management and workload), image repository information and definition components. Note that any suitable cluster deployment platform may be used, such as TKG introduced using FIG. 1, etc. Cluster add-on definition information 160 may further specify a BOM file associated with the cluster deployment platform (see “clusterDeploymentPlatformBomRelease”).

At 420 in FIG. 4, cluster add-on definition information 160 may specify a BOM file (see “addonBomRelease”) that defines multiple cluster add-ons for extending the functionality of management cluster 130 and/or workload cluster 140. In particular, at 430, the “addonBomRelease” file may specify include configuration fields to define version information, image repository information, package repository information and various components (e.g., add-ons).

At 440 in FIG. 4, the “addonBomRelease” file may include an “addons” section specifying multiple add-ons. Each cluster add-on may be associated with name (see “addon-name”), category 460, tags 460 (e.g., management, workload, core, exclusive), capabilities 470 (e.g., IPv6 support), etc. Each cluster add-on also may be associated with configuration schema information 480 (see “configSchema”) and/or status monitoring schema information 490 (see “statusSchema”).

At 450 in FIG. 4, example categories may include container network interface (CNI), container storage interface (CSI), system, core, networking, etc. The CSI may be a specification that is designed to enable persistent storage volume management on Container Orchestrators (COs) such as Kubernetes, etc. The specification allows storage systems to integrate with containerized workloads running on Kubernetes. Using CSI, storage providers, such as VMware, can write and deploy plug-ins for storage systems in Kubernetes without a need to modify any core Kubernetes code. The CNI may connect Pods across nodes, acting as an interface between a network namespace and a network plug-in or a network provider and a Kubernetes network.

At 460-470 in FIG. 4, tags (e.g., “management” and “workload”) and capabilities (e.g., “IPv6” support) may be defined for a cluster add-on. Tag=“management” indicates the cluster add-on is installable in management cluster 130. Tag “workload” indicates the cluster add-on is installable in workload cluster 140. Tag=“core” indicates a core add-on that is installable automatically when a corresponding cluster is created. Tag=“service” indicates a service add-on that is installable to provide additional functionalities not available through core add-on(s). Tag=“exclusive” indicates an add-on is exclusively installed in its category. Depending on the desired implementation, user 152 may not be allowed to uninstall core add-on(s) until the cluster is deleted. In contrast, service add-on(s) may be installed or uninstalled on demand. For example, user 152 may install both core add-on(s) and service add-on(s) on day 1, upgrade the add-on(s) on day 2 and perform status monitoring.

At 480 in FIG. 4, cluster add-on definition information 160 may include configuration schema information (see “configSchema”) specifying multiple configuration fields associated with a particular cluster add-on. For example, configuration schema information 480 may be defined according to an open API specification that defines a programming language-agnostic interface description for Hypertext Transfer Protocol (HTTP) APIs.

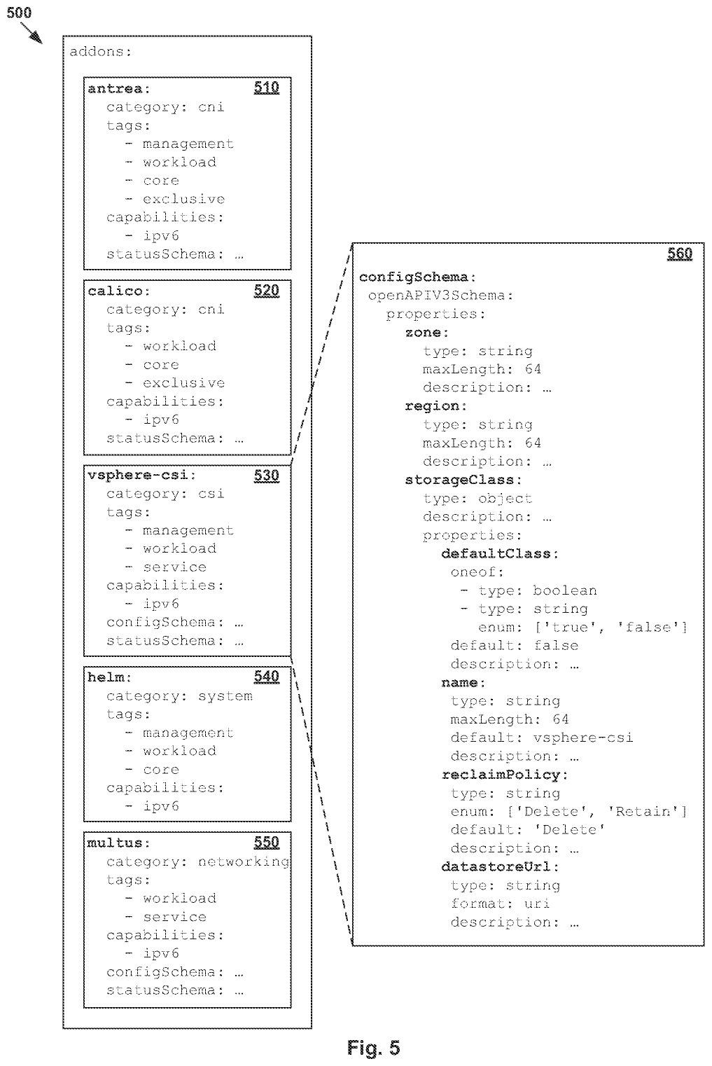

Multiple configuration fields (see “properties”) may be defined. For example, a first configuration field (see “property-name1”) may be defined using type=string, maximum length (e.g., 64) and associated description. A second configuration filed (see “property-name2”) may be defined using type=string whose value may be one of multiple predefined values listed in the enumerations field (see “enum: [‘op1’, ‘op2’]), default value (e.g., op1) and associated description. Some examples will be described using FIGS. 5-8 below.

At 490 in FIG. 4, cluster add-on definition information 160 may include status monitoring schema information (see “statusSchema”) specifying status information to be collected and monitored for a cluster add-on. For each type of status information, associated name, namespace and expected status may be defined. Some examples will be described using FIGS. 15-16 below.

In practice, cluster add-on definition information 160 may be generated based on a capability matrix associated with multiple cluster add-ons. For each cluster add-on, the matrix may include an entry specifying one or more of the following: tags (e.g., core add-on or service add-on), capabilities (e.g., IPv6 support), category (e.g., CSI, CNI, etc.), cluster type (e.g., management and/or workload) and user-allowed operations (e.g., install, uninstall, update, upgrade, monitor). For example, user-allowed operations for a core add-on may include upgrade and monitor, but exclude install, uninstall and update. In contrast, user-allowed operations for a service add-on may include install, uninstall, update, upgrade and monitor.

(b) Example Add-Ons and UIs

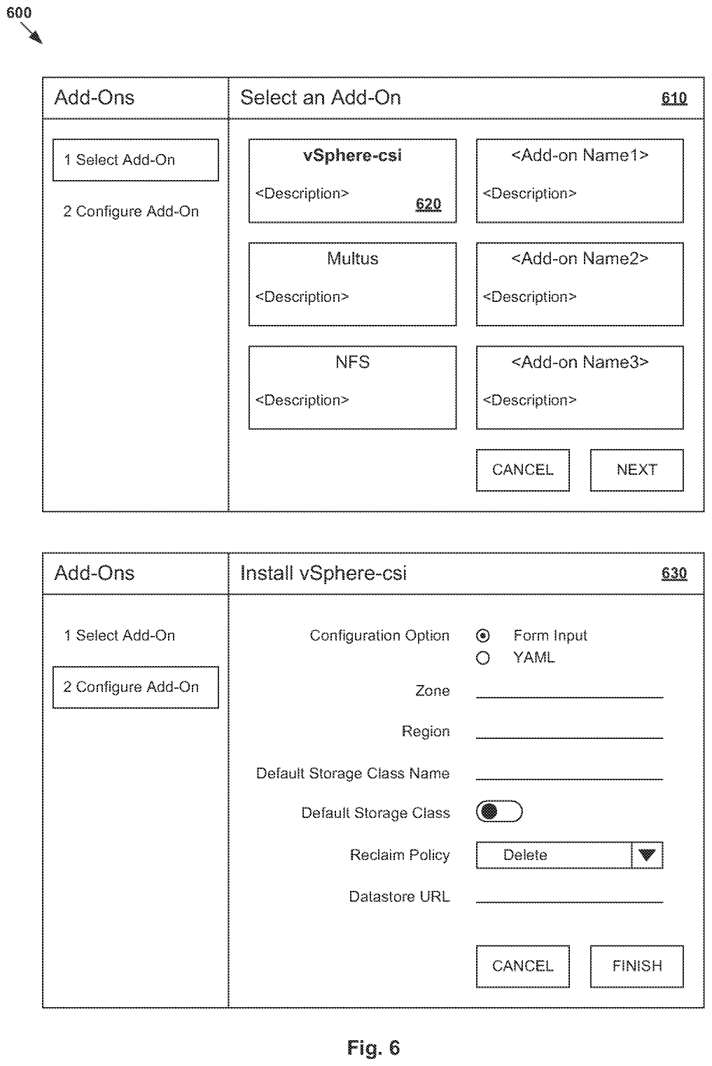

FIG. 5 is a schematic diagram illustrating first example 500 of cluster add-on definition information specifying multiple add-ons. The example in FIG. 5 will be described using FIG. 6, which is a schematic diagram illustrating first example user interfaces 600 for cluster add-on lifecycle management. In this example, cluster add-on definition information 160 may specify multiple add-ons, such as Antrea (see 510) and Calico (see 520) in category=CNI, vSphere-csi (see 530) in category=CSI, helm (see 540) in category=system and multus (see 550) in category=networking.

In practice, Antrea is a Kubernetes networking solution that operates at layer 3/4 to provide networking and security services for a Kubernetes cluster, leveraging Open vSwitch as the networking data plane. Calico is a networking and network policy provider that supports a flexible set of networking options. vSphere-csi is a plug-in that runs in a native Kubernetes cluster deployed in VMware vSphere® and is responsible for provisioning persistent volumes on vSphere storage. Helm is a package manager that facilitates application installation and management in Kubernetes clusters. Multus is a CNI manager that facilitates attachment of multiple network interfaces to pods.

Each cluster add-on is associated with any suitable tags, capabilities, configuration schema information, status schema information, or any combination thereof. For example, configuration schema information (see 560) associated with add-on=vSphere-csi may specify multiple configuration fields, such as zone (e.g., string with maxLength=64), region (e.g., string with maxLength=64), and storage class (e.g., object with multiple properties). Field=storage class may be associated with a default class (e.g., Boolean value indicating whether vSphere CSI storage is default or otherwise), name (e.g., string), reclaim policy of persistent volume (e.g., string from enumeration that includes “Delete” and “Retain”), datastore URL (e.g., format=uniform resource identifier (URI)), etc.

Based on the example in FIG. 5, MP entity 110 (e.g., UI module 112) may generate and provide UI element(s) or widget(s) to allow user 152 to request for any suitable management action, such as cluster add-on installation, update, upgrade, status monitoring and uninstallation. Any suitable UI elements may be generated based on configuration schema information associated with a cluster add-on. A particular UI element on a graphical UI (GUI) may be a window, button, menu, text box, list, application icon, menu bar, scroll bar, title bar, status bar, size grip, toolbar, dropdown list (e.g., for enumeration), or any combination thereof, etc.

In the example in FIG. 6, a first UI (see 610) may include UI elements specifying multiple add-ons that are selectable by user 152 for installation in a particular cluster, including service add-ons such as vSphere-csi (see 620) in FIG. 5. A second UI (see 630) may include UI elements specifying multiple configuration fields associated with selected cluster add-on=vSphere-csi, including zone, region, default storage class name, whether vSphere-csi is the default, reclaim policy and datastore URL. Through second UI 630, MP entity 110 may receive input of configuration values associated with the respective configuration fields.

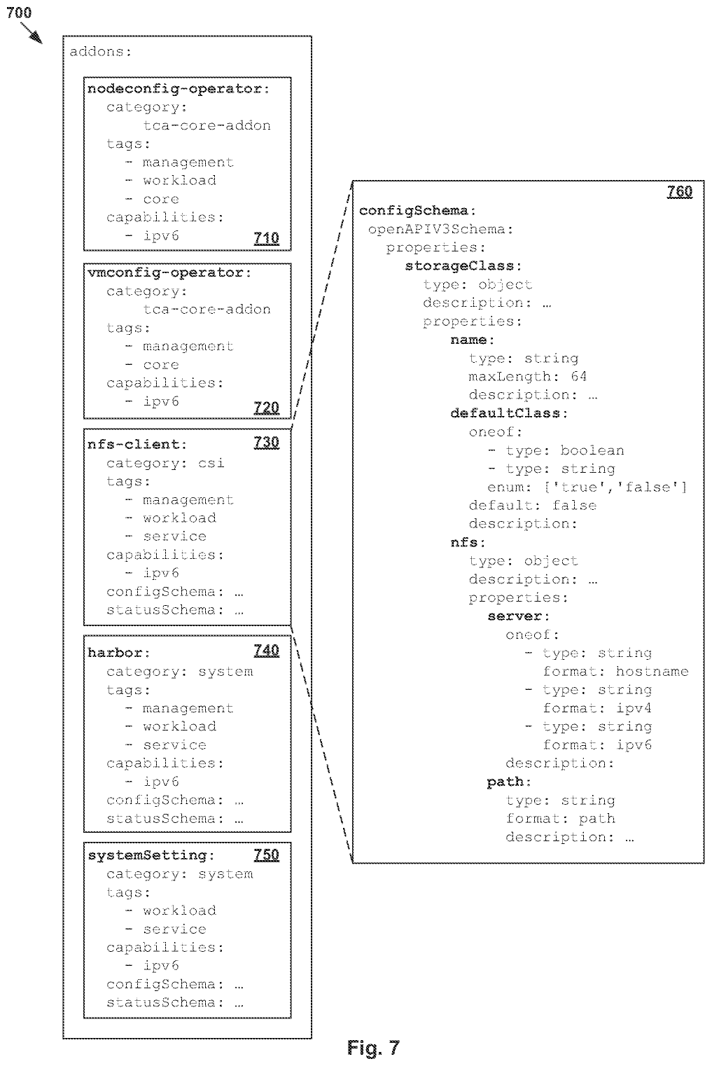

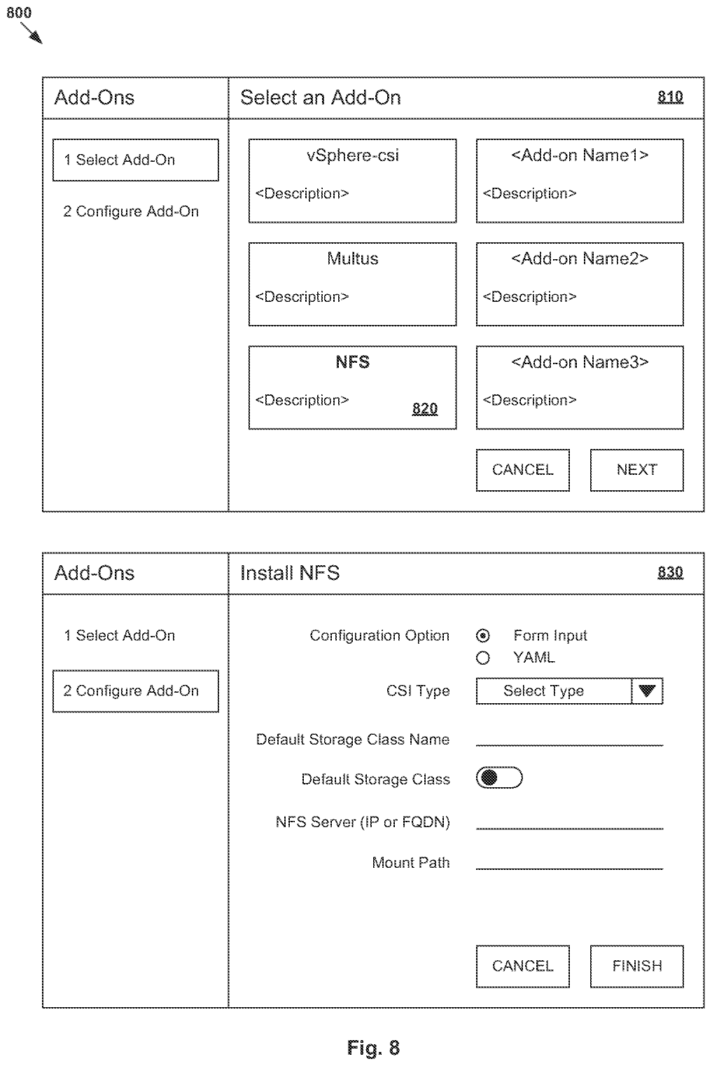

FIG. 7 is a schematic diagram illustrating second example 700 of cluster add-on definition information specifying multiple add-ons. The example in FIG. 7 will be described using FIG. 8, which is a schematic diagram illustrating second example user interfaces 800 for cluster add-on lifecycle management. In this example, cluster add-on definition information 160 may specify multiple add-ons, such as nodeconfig-operator (see 710) and vmconfig-operator (see 720) in category=tca-core-addon, network file system (NFS) in category=CSI (see 730), Harbor™ (see 740) and systemSetting (see 750) in category=system.

Similar to the examples in FIGS. 4-5, each cluster add-on is associated with any suitable tags, capabilities, configuration schema information, status schema information, or any combination thereof. For example, configuration schema information (see 760) associated with add-on=NFS-client may specify multiple configuration fields. For example, field=storage class (e.g., object) is associated with name (e.g., string), default class (e.g., Boolean value indicating whether NFS is default), NFS server parameters (e.g., object), etc. The NFS server parameters may include server hostname and address (e.g., strings) and a path on NFS server that stores persistence volumes.

Based on the example in FIG. 7, MP entity 110 (e.g., UI module 112) may generate and provide UI(s) to allow user 152 to request for any suitable management action, such as cluster add-on installation, update, upgrade, status monitoring and uninstallation. In the example in FIG. 8, a first UI (see 810) may be generated to specify multiple add-ons that are selectable by user 152 for installation in a particular cluster, including service add-ons such as NFS (see 820) in FIG. 7. A second UI (see 830) may be generated to specify multiple configuration fields associated with selected cluster add-on=NFS, including default storage class name, whether NFS is the default, NFS server's IP address or hostname and mount path. This way, MP entity 110 may receive input of configuration values associated with the respective configuration fields via second UI 830.

As will be described below, cluster add-on definition information 160 may be shared or accessed by multiple layers or planes in network environment 100, i.e., from MP entity 110 (including UI module 112) to CP entity 120 and cluster operator 132 to perform cluster add-on lifecycle management.

Management Cluster Creation and Core Add-on Installation

FIG. 9 is a flowchart of example process 900 to perform management cluster creation and core add-on installation based on cluster add-on definition information. Example process 900 may include one or more operations, functions, or actions illustrated by one or more blocks, such as 910 to 995. Depending on the desired implementation, various blocks may be combined into fewer blocks, divided into additional blocks, and/or eliminated.

At 910 in FIG. 9, MP entity 110 may detect a request to perform action=create management cluster 130 from user 152 via UI(s) generated by UI module 112 based on cluster add-on definition information (see 901). In response, at 920, MP entity 110 may generate and send instruction(s) to CP entity 120 to cause CP entity 120 to create management cluster 130 and install core add-on(s) associated with management cluster 130. For example, at 930, CP entity 120 may initiate management cluster creation using any suitable approach, such as via Kubernetes BootStrapper (KBS) 902, etc. In practice, KBS 902 may be a daemon running on CP entity 120 (e.g., TCA-CP appliance) that exposes REST API to operate cluster and cluster add-on(s).

At 940 in FIG. 9, CP entity 120 may query status information to determine whether management cluster 130 is up and running via KBS 902. At 950, once management cluster 130 is up and running, CP entity 120 may install management cluster operator 132 in management cluster 130 via KBS 902. For example, the installation may be performed using Helm by The Linux Foundation® discussed above.

In practice, cluster operator 132 may be considered to be a type of management cluster core add-on that is installed by default after management cluster 130 is provisioned. Cluster operator 132 may be configured to manage workload clusters 140. To facilitate lifecycle management, cluster operator 132 may include any suitable component(s), such as cluster add-on controller/manager 134 shown in FIG. 1, etc. Cluster operator 132 may support an abstract layer to provide lifecycle management support for various types of cluster add-ons. At 960, CP entity 120 may query status information associated with cluster operator 132 and pod(s) in management cluster 130 via KBS 902.

At 970 in FIG. 9, CP entity 120 may generate and send instruction(s) to instruct cluster operator 132 to perform core add-on installation based on cluster add-on definition information 901 associated with management cluster 130. Each instruction may be in the form of a custom resource (CR). In general, a “resource” may refer generally to an endpoint in the Kubernetes API that stores a collection of API objects of a certain kind. A “custom resource” may refer generally to an extension or customization of a particular Kubernetes installation.

At 980 in FIG. 9, in response to receiving an instruction from CP entity 120, cluster operator 132 running within management cluster 130 may perform core add-on installation. In particular, at 980(1-2), cluster operator 132 may retrieve/obtain cluster add-on definition information 901 to identify core add-on(s) associated with management cluster 130. For example, this may involve inspecting tag information to search for tags=“core” and “management” in cluster add-on definition information 901. Next, at 980(3), cluster operator 132 may automatically create CR(s) associated with the core add-on(s) to facilitate the installation. Further, at 980(4), any suitable monitoring to determine whether the installation is successful.

At 990 in FIG. 9, CP entity 120 may query core add-on CR(s) created by cluster operator 132. At 995, CP entity 120 may store the core add-on CR(s) in a datastore and perform status monitoring.

Workload Cluster Creation and Core Add-on Installation

FIG. 10 is a flowchart of example process 1000 to perform workload cluster creation and core add-on installation based on cluster add-on definition information. Example process 1000 may include one or more operations, functions, or actions illustrated by one or more blocks, such as 1010 to 1070. Depending on the desired implementation, various blocks may be combined into fewer blocks, divided into additional blocks, and/or eliminated.

At 1010 in FIG. 10, MP entity 110 may detect a request to perform action=create workload cluster 140 from user 152 via UI module 112. In response, at 1020, MP entity 110 may generate and send an instruction to CP entity 120 to cause CP entity 120 to create workload cluster 140 and install core add-on(s) associated with workload cluster 140. At 1030, CP entity 120 may initiate workload cluster creation by sending an instruction (see “create workload cluster CR”) to cluster operator 132.

At 1040 in FIG. 10, cluster operator 132 may perform workload cluster creation and core add-on installation associated with workload cluster 140. In particular, at 1040(1), workload cluster 140 may be created/installed. At 1040(2-3), cluster operator 132 may retrieve cluster add-on definition information (see 1001) to identify core add-on(s) associated with workload cluster 140. For example, this may involve inspecting tag information to search for tags=“core” and “workload.” Further, at 1040(4-5), cluster operator 132 may automatically create CR(s) associated with the core add-on(s) identified at block 1043 for installation. At 1040(6), any suitable monitoring operation(s) associated with the core add-on(s) may be performed.

At 1050 in FIG. 10, once workload cluster creation and core add-on installation have been performed successfully, CP entity 120 may report to MP entity 110. At 1060-1060, CP entity 120 may query core add-on CR(s) created by cluster operator 132 and store the core add-on CR(s) associated with workload cluster 140 in a datastore and perform add-on status monitoring.

Service Add-on Installation and Uninstallation

FIG. 11 is a flowchart of example detailed process 1100 for service add-on installation based on cluster add-on definition information and uninstallation. Example process 1100 may include one or more operations, functions, or actions illustrated by one or more blocks, such as 1110 to 1190. Depending on the desired implementation, various blocks may be combined into fewer blocks, divided into additional blocks, and/or eliminated. The example in FIG. 11 will be explained using FIG. 12, which is a schematic diagram illustrating example CR with a secret definition for service add-on installation 1200 W.

Unlike core add-on installation that is performed during cluster creation, service add-on installation may be driven by user demand. According to examples of the present disclosure, MP entity 110 may provide user 152 with UI(s) supported by UI module 112 to install service add-on(s) with or without customized configuration. In the following, example CR 1210 with its secret definition (e.g., Kubernetes secrets) may be defined to facilitate service add-on installation, but it should be understood that any alternative approach may be used in practice. In practice, a “secret” may refer generally to an object that includes sensitive or confidential information. In the following, the term “secret definition” may refer generally to information associated with a Kubernetes secret. Example CR 1210 and its secret definition may present a user's intent to install add-on(s) with customized configuration value(s) in secret, such as to protect sensitive configuration value(s).

(a) Installation

At 1105 in FIG. 11, user 152 may interact with UI(s) generated by UI module 112 to select a service add-on for installation. Using the example in FIGS. 5-6, the UI(s) may specify multiple add-ons including vSphere-csi, etc. Service add-ons may be installed in management cluster 130 and/or workload cluster 140.

At 1110 in FIG. 11, MP entity 110 may detect a request to perform management action=enable or install a service add-on in a target cluster from user 152 via UI module 112. For example, the request may be in the form of a HTTP POST request, such as “POST cluster/<uuid>/addon” that is sent by UI module 112 to MP entity 110. At 1120, in response, MP entity 110 may generate and send instruction(s) to CP entity 120 to cause CP entity 120 to perform service add-on installation.

In the example in FIG. 12 (related to FIG. 5), MP entity 110 may detect a request to install service add-on=vSphere-csi in target cluster=management cluster 130 or workload cluster 140. Based on “configSchema” information defined for the service add-on, UI module 112 may provide a UI for user 152 to specify multiple configuration values associated with respective multiple configuration fields, such as (a) zone, (b) region and (c) storage class that is associated with a default class, name and datastore URL, etc.

At 1130 in FIG. 11, CP entity 120 may generate and send an instruction to cluster operator 132 to proceed with the service add-on installation. The instruction from CP entity 120 may specify a CR with a secret definition (see “create addon secret and CR”) in YAML format. The secret definition includes multiple configuration values associated with the service add-on.

In the example in FIG. 12, CR 1210 may include a secret definition (see “kind: Secret” and “values.yaml”) specifying multiple configuration values associated with respective multiple configuration fields. For secret add-on=vsphere.csi, example configuration values may be include: (a) zone=“zone1,” (b) region=“region1” and (c) storageClass with defaultClass=“true,” name=“vSphere-csi-default-ss” and datastoreUrl=“ds:///vmfs/volumes/vsan:522d04fab08b1444-1 ce5e550163e4773/.” See 1220-1250 in FIG. 12.

At 1140 in FIG. 11, cluster operator 132 (e.g., using add-on controller 134) may perform service add-on installation based on the instruction from CP entity 120 according to steps (1-5). In particular, at 1140(1), cluster operator 132 may retrieve cluster add-on definition information 1101 associated with target cluster 130/140. At 1140(2), cluster operator 132 may identify the service add-on from cluster add-on definition information 1101 (e.g., to verify that the service add-on is defined) and inspect its configuration fields.

At 1140(3), cluster operator 132 may perform any suitable pre-validation setup, such as filling in default configuration value(s) for associated configuration field(s) based on value(s) defined in cluster add-on definition information 1101 (if not provided by user 152). At 1140(4), cluster operator 132 may perform any suitable validation operation(s) based on cluster add-on definition information 1101 and configuration values include in the instruction from CP entity 120. The validation operation(s) may be customizable according to the service add-on. Any suitable validation operation(s) may be performed.

In a first example, the validation operation may include a format validation for multiple configuration values associated with the service add-on. In this case, cluster operator 132 may inspect each configuration value defined for the service add-on in the secret definition (e.g., under values.yaml at 1240 in FIG. 12) and determine whether it has a valid format based on the defined format under “configSchema” in cluster add-on definition information 1101. For example in FIG. 12, configuration fields (a) zone and (b) region are defined with type=string with maxLength=64. In this case, corresponding configuration values (a) zone=“k8s-zone” and (2) region=“k8s-region” may be validated to ensure that the format (i.e., type and length) are correct.

In a second example, the validation operation may include performing add-on specific validation that is generally more complex that the format validation above, such as configuration value validation, cross-argument validation, etc. In the case of configuration value validation, if a configuration value is a resource in another system, it is determined whether the resource is present and the configuration value is valid. Using the example in FIG. 12, for configuration values (1) zone=“k8s-zone” and (2) region=“k8s-region,” it is determined whether a corresponding storage topology is well tagged on VMware vSphere® vCenter®, etc. For (3) storageClass, it is determined whether the datastore URL is valid. Here, cluster operator 132 may be programmed or implemented to check whether resources are created as expected on third party component(s). The add-on specific validation may also include cross-argument validation, such as whether one configuration value depends on another value.

At 1140(5-6) in FIG. 11, cluster operator 132 may install the service add-on in target cluster 130/140 and configure the service add-on based on associated configuration values. The installation process may depend on the service add-on, such as by leveraging Helm (discussed above), cluster add-on controller 134, Carvel kapp-controller, etc. In practice, kapp-controller is a tool in the open source Carvel suite to facilitate application deployment and management.

At 1140(6) in FIG. 11, in case of any failure, cluster operator 132 may perform reconciliation to reconcile a current state associated with target cluster 130/140 with a desired state=service add-on installed. In general, the desired state represents object(s) that should exist in a cluster, while the current state represents object(s) that actually exist in the cluster. Through the reconciliation, cluster operator 132 may adjust the current state to match the desired state. For example, in case of any error during validation or installation, cluster operator 132 may keep trying until the validation or installation is successful. The failure(s) or error(s) may be presented to user 152 via a UI for add-on status monitoring. In response to detecting an error, cluster operator 132 may generate a notification/alarm such that user 152 may fix and apply the configuration again.

At 1150 in FIG. 11, MP entity 110 may detect a request to perform management action=obtain status information associated with a service add-on installed in cluster 130/140 from user 152 via UI module 112. For example, HTTP GET requests may be used, such as “GET cluster/<uuid>/addon<uuid>” and “GET cluster/<uuid>/addon<uuid>/status.” At 1160, MP entity 110 may generate and send a query to CP entity 120 to obtain status information associated with the service add-on. This way, at 1170, the status information may be reported to user 152 via UI(s) supported by UI module 112.

(b) Uninstallation

At 1175 in FIG. 11, MP entity 110 may detect a request to perform management action=disable or uninstall a service add-on in a target cluster from user 152 via UI module 112. For example, the request may be in the form of a HTTP DELETE request, such as “DELETE cluster/<uuid>/addon<uuid>.” At 1180, in response to detecting the request, MP entity 110 may generate and send an instruction to cause CP entity 120 to perform service add-on uninstallation.

At 1185 in FIG. 11, CP entity 120 may generate and send instruction(s) to cause cluster operator 132 to perform the service add-on uninstallation, such as by deleting associated service add-on CR with secret definition. At 1190, cluster operator 132 may perform the service add-on uninstallation by marking the CR as deleted, undeploy the service add-on, removing the service add-on, etc.

In practice, CP entity 120 may delete add-on CR(s) and cluster operator 132 may reconcile the deletion operation. This way, when some dependent conditions are met, a particular add-on CR may be removed. In some cases, for example, the add-on CR may be held in a deleting phase until associated managed resources are cleared. Cluster operator 132 may reconcile the resource cleaning up process, after which the add-on CR is deleted. As will be described using FIGS. 15-16, status monitoring associated with any deleted add-on CR(s) will also be stopped.

Cluster Add-on Update

FIG. 13 is a flowchart of example detailed process 1300 for cluster add-on update based on cluster add-on definition information. Example process 1300 may include one or more operations, functions, or actions illustrated by one or more blocks, such as 1310 to 1380. Depending on the desired implementation, various blocks may be combined into fewer blocks, divided into additional blocks, and/or eliminated. Note that the examples below are applicable to service and core add-on(s).

At 1310 in FIG. 13, user 152 may interact with UI(s) supported by UI module 112 to browse a cluster add-on UI specifying installed cluster add-on(s) in cluster 130/140. At 1320, UI module 112 may retrieve relevant cluster add-on definition information 1301 and generate UI(s) specifying multiple configuration fields associated a particular add-on. At 1330, user 152 may update configuration value(s) associated with the add-on via UI(s) supported by UI module 112.

At 1340 in FIG. 13, MP entity 110 may detect a request to perform management action=update cluster add-on in a target cluster based on updated configuration value(s) from user 152 via UI module 112. For example, the request may include a HTTP PUT request, such as “PUT cluster/<uuid>/addon.” At 1350-1360, in response, MP entity 110 may generate and send an instruction to CP entity 120, which in turn instructs cluster operator 132 to apply the updated configuration value(s) associated with the add-on.

At 1370 in FIG. 13, the instruction from CP entity 120 to cluster operator 132 may specify a CR with a secret definition (see “create addon secret and CR”) in YAML format. The secret definition includes at least one updated configuration value associated with the add-on. In this example, configuration field=zone may be updated to specify “zone2” (see FIG. 13 at 1370) instead of “zone1” (see FIG. 12 at 1250) under the secret definition (see “kind: Secret” and “values.yaml”).

At 1380 in FIG. 13, cluster operator 132 may inspect the updated configuration value(s) and perform validation operation(s) based on cluster add-on definition information 1301. Similar to the example in FIG. 11, the validation operation may involve format validation, configuration value validation, cross-argument validation, or any combination thereof. Prior to performing the validation operation, default value generation may be performed to fill in default value(s) not provided by user 152. In response to a successful validation, the updated configuration value(s) may be applied. In case of any error during validation or configuration update, cluster operator 132 may perform reconciliation until the validation or configuration update is successful. Any failure(s) or error(s) may be presented such that user 152 may fix and apply the update again. See steps (1)-(6) of 1380 in FIG. 13.

Cluster Add-on Upgrade

FIG. 14 is a flowchart of example detailed process 1400 for cluster add-on upgrade based on cluster add-on definition information. Example process 1400 may include one or more operations, functions, or actions illustrated by one or more blocks, such as 1410 to 1450. Depending on the desired implementation, various blocks may be combined into fewer blocks, divided into additional blocks, and/or eliminated.

At 1410 in FIG. 14, MP entity 110 may detect an interaction of user 152 with UI(s) supported by UI module 112 to browse to cluster add-on UI(s) specifying installed cluster add-on(s) in cluster 130/140. The UI(s) may be generated based on updated cluster add-on definition information (see 1401 in FIG. 14) associated with target cluster(s).

At 1420 in FIG. 14, MP entity 140 may detect a request to perform management action=upgrade cluster and cluster add-on in a target cluster from user 152 via UI module 142. In practice, the upgrade of both the cluster and cluster add-on may be triggered by change(s) made to cluster add-on definition information 1401 associated with the cluster. For example, the request may include a HTTP PUT request, such as “PUT cluster/<uuid>.” At 1430-1440 in FIG. 14, in response to detecting the request, MP entity 140 may generate and send an instruction to CP entity 120, which in turn instruct cluster operator 132 to perform the upgrade based on updated cluster add-on definition information 1401.

At 1450 in FIG. 14, cluster operator 132 may perform cluster upgrade according to steps (1)-(5). For example, cluster operator 132 may obtain updated cluster add-on definition information 1401 and identify cluster add-ons that are installed in a particular cluster. For each add-on, it is determined whether the add-on version has changed. If changed, the old version is uninstalled and the new version installed based on updated cluster add-on definition information 1401. In case of any error, cluster operator 132 may perform reconciliation until the validation or configuration update is successful.

Status Monitoring

FIG. 15 is a flowchart of example detailed process 1500 for cluster add-on status monitoring based on cluster add-on definition information. Example process 1500 may include one or more operations, functions, or actions illustrated by one or more blocks, such as 1510 to 1560. Depending on the desired implementation, various blocks may be combined into fewer blocks, divided into additional blocks, and/or eliminated.

At 1510 in FIG. 15, CP entity 120 may monitor any status change associated with a particular cluster add-on that is installed in cluster 130/140. Block 1510 may involve querying cluster operator 132 for status information and performing status monitoring (see 1512-1514). Operation 1514 may involve updating a database with add-on status information and removing any add-on that has been removed/uninstalled.

At 1520 in FIG. 15, MP entity 140 may detect a request to perform management action=cluster add-on status monitoring from user 152 via UI module 142. The request may be detected when user 152 browses a page specifying multiple add-ons that have been installed in cluster 130/140. The request may include HTTP GET requests, such as “GET cluster/<uuid>/<addon>/<uuid>” and “GET cluster/<uuid>/<addon>/<uuid>/status.”

In response, at 1530-1540 in FIG. 15, MP entity 110 may generate and send a query to CP entity 120, which queries a local database that stores status information associated with multiple add-ons. At 1550-1560, the requested status information may be provided to MP entity 110 and subsequently to user 152 via UI(s) generated and provided by UI module 112.

Depending on the desired implementation, cluster add-on definition information may include status schema information to facilitate status monitoring and reporting. An example is shown in FIG. 16, which is a schematic diagram illustrating example cluster add-on definition information and UI for cluster add-on status monitoring. Here, example status schema information 1610 associated with service add-on=vSphere-csi (see also 530 in FIG. 5) may specify status information items to be reported. Each item may be associated with a type (e.g., app), name, namespace and expected status.

Example UI 1620 may include multiple UI elements specifying status information associated with multiple add-ons installed in a particular workload cluster (e.g., “workloadcluster-chicago” with status=healthy). Installed add-ons may be organized according to various categories, such as vSphere-csi in category=CSI as well as Antrea and Multus in category=CNI. As user 152 navigates to different categories (e.g., All, CNI, CSI, Networking, etc.), status information associated with various add-ons may be retrieved and displayed according to the example in FIG. 15.

Computer System(s)

Depending on the desired implementation, a Kubernetes cluster may include any suitable pod(s). A pod is generally the smallest execution unit in Kubernetes and may be used to encapsulate one or more applications. Some example pods are shown in FIG. 17, which is a schematic diagram illustrating example software-defined networking (SDN) environment 1700 in which cluster add-on lifecycle management may be performed. Depending on the desired implementation, SDN environment 1700 may include additional and/or alternative components than that shown in FIG. 17. Here, SDN environment 1700 may include any number of hosts, such as hosts 1710A-B (also known as “computer systems,” “computing devices”, “host computers).

Host 1710A/1710B may include suitable hardware 1712A/1712B and virtualization software (e.g., hypervisor-A 1714A, hypervisor-B 1714B) to support various VMs. For example, host-A 1710A may support VM1 1731 on which POD1 1741 is running, as well as support VM2 1732 on which POD2 1742 is running. Host-B 1710B may support, while VM3 1733 on which POD3 1743 and POD4 1744 are running. Hardware 1712A/1712B includes suitable physical components, such as central processing unit(s) (CPU(s)) or processor(s) 1720A/1 720B; memory 1722A/1722B; physical network interface controllers (PNICs) 1724A/1724B; and storage disk(s) 1726A/1 726B, etc.

Hypervisor 1714A/1714B maintains a mapping between underlying hardware 1712A/1 712B and virtual resources allocated to respective VMs. Virtual resources are allocated to respective VMs 1731-1733 to support a guest operating system (OS; not shown for simplicity) and application(s); see 1751-1753. For example, the virtual resources may include virtual CPU, guest physical memory, virtual disk, virtual network interface controller (VNIC), etc. Hardware resources may be emulated using virtual machine monitors (VMMs). For example in FIG. 17, VNICs 1761-1764 are virtual network adapters, respectively, and are emulated by corresponding VMMs (not shown) instantiated by their respective hypervisor at respective host-A 1710A and host-B 1710B. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 1714A-B may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-17” may refer generally to a link layer or media access control (MAC) layer; “layer-3” a network or Internet Protocol (IP) layer; and “layer-4” a transport layer (e.g., using TCP, User Datagram Protocol (UDP), etc.), in the Open System Interconnection (OSI) model, although the concepts described herein may be used with other networking models.

SDN controller 1770 and SDN manager 1772 are example network management entities in SDN environment 1700. One example of an SDN controller is the NSX controller component of VMware NSX® (available from VMware, Inc.) that operates on a central control plane. SDN controller 1770 may be a member of a controller cluster (not shown for simplicity) that is configurable using SDN manager 1772. Network management entity 1770/1772 may be implemented using physical machine(s), VM(s), or both. To send or receive control information, a local control plane (LCP) agent (not shown) on host 1710A/1710B may interact with SDN controller 1770 via control-plane channel 1701/1702.

Through virtualization of networking services in SDN environment 1700, logical networks (also referred to as overlay networks or logical overlay networks) may be provisioned, changed, stored, deleted and restored programmatically without having to reconfigure the underlying physical hardware architecture. Hypervisor 1714A/1 714B implements virtual switch 1715A/1 715B and logical distributed router (DR) instance 1717A/1 717B to handle egress packets from, and ingress packets to, VMs 1731-1733. In SDN environment 1700, logical switches and logical DRs may be implemented in a distributed manner and can span multiple hosts.

For example, a logical switch (LS) may be deployed to provide logical layer-17 connectivity (i.e., an overlay network) to VMs 1731-1733. A logical switch may be implemented collectively by virtual switches 1715A-B and represented internally using forwarding tables 1716A-B at respective virtual switches 1715A-B. Forwarding tables 1716A-B may each include entries that collectively implement the respective logical switches. Further, logical DRs that provide logical layer-3 connectivity may be implemented collectively by DR instances 1717A-B and represented internally using routing tables (not shown) at respective DR instances 1717A-B. Each routing table may include entries that collectively implement the respective logical DRs.

Packets may be received from, or sent to, each VM via an associated logical port (see 1765-1768). Here, the term “logical port” or “logical switch port” may refer generally to a port on a logical switch to which a virtualized computing instance is connected. A “logical switch” may refer generally to a software-defined networking (SDN) construct that is collectively implemented by virtual switches 1715A-B, whereas a “virtual switch” may refer generally to a software switch or software implementation of a physical switch. In practice, there is usually a one-to-one mapping between a logical port on a logical switch and a virtual port on virtual switch 1715A/1 715B. However, the mapping may change in some scenarios, such as when the logical port is mapped to a different virtual port on a different virtual switch after migration of the corresponding virtualized computing instance (e.g., when the source host and destination host do not have a distributed virtual switch spanning them).

A logical overlay network may be formed using any suitable tunneling protocol, such as Virtual eXtensible Local Area Network (VXLAN), Stateless Transport Tunneling (STT), Generic Network Virtualization Encapsulation (GENEVE), Generic Routing Encapsulation (GRE), etc. For example, VXLAN is a layer-17 overlay scheme on a layer-3 network that uses tunnel encapsulation to extend layer-17 segments across multiple hosts which may reside on different layer 17 physical networks. Hypervisor 1714A/1 714B may implement virtual tunnel endpoint (VTEP) 1719A/1 719B to encapsulate and decapsulate packets with an outer header (also known as a tunnel header) identifying the relevant logical overlay network (e.g., VNI). Hosts 1710A-B may maintain data-plane connectivity with each other via physical network 1705 to facilitate east-west communication among VMs 1731-1733.

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 17.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described or can be alternatively located in one or more devices different from that in the examples. The units in the examples described can be combined into one module or further divided into a plurality of sub-units.

1. A method for a computer system capable of implementing a management entity to perform cluster add-on lifecycle management, wherein the method comprises:
obtaining cluster add-on definition information specifying multiple add-ons that are each capable of extending functionality of at least a first cluster and a second cluster, wherein the multiple add-ons include a first add-on associated with multiple first configuration fields and a second add-on associated with multiple second configuration fields;
generating one or more user interfaces based on the cluster add-on definition information to allow a user to request for a management action associated with at least one of the multiple cluster add-ons;
in response to receiving a first request for a first management action associated with the first add-on via a first user interface, generating and sending a first instruction to cause the first management action to be performed in the first cluster based on multiple first configuration values associated with the respective multiple first configuration fields; and
in response to receiving a second request for a second management action associated with the second add-on via a second user interface, generating and sending a second instruction to cause the second management action to be performed in the first cluster or the second cluster based on multiple second configuration values associated with the respective multiple second configuration fields.

2. The method of claim 1, wherein generating the one or more user interfaces comprises:
generating the one or more user interface to allow the user to request at least one of the following management actions: (a) cluster creation and installation of one or more core add-ons specified by the cluster add-on definition information, (b) installation or uninstallation of a particular service add-on specified by the cluster add-on definition information, and (c) updating, upgrading or status monitoring for a particular add-on specified by the cluster add-on definition information.

3. The method of claim 1, wherein generating and sending the first instruction comprises:
generating and sending the first instruction to perform the first management action in the form of creating the first cluster and installing the first add-on in the first cluster, wherein the first add-on is a core add-on and the first cluster is either a management cluster or a workload cluster.

4. The method of claim 3, wherein generating and sending the first instruction comprises:
generating and sending the first instruction to perform the first management action in the form of updating or upgrading the first add-on in the first cluster, wherein the first cluster is either a management cluster or a workload cluster.

5. The method of claim 1, wherein generating and sending the second instruction comprises:
generating and sending the second instruction to perform the management action in the form of installing, updating or upgrading the second add-on in the second cluster, wherein the second add-on is a service add-on and the second cluster is either a management cluster or a workload cluster.

6. The method of claim 5, wherein providing the one or more user interfaces comprises:
identifying, from the cluster add-on definition information, configuration schema information specifying the multiple second configuration fields associated with the second add-on; and
generating a particular user interface that includes multiple user interface elements to allow an input of the multiple second configuration values associated with the respective multiple second configuration fields.

7. The method of claim 1, wherein generating and sending the first or second instruction comprises:
generating and sending the first instruction or second instruction from the management entity to a control plane (CP) entity that is capable of instructing a cluster operator to perform the first management action or second management action.

8. A non-transitory computer-readable storage medium that includes a set of instructions which, in response to execution by a processor of a computer system, cause the processor to perform a method of cluster add-on lifecycle management, wherein the method comprises:
obtaining cluster add-on definition information specifying multiple add-ons that are each capable of extending functionality of at least a first cluster and a second cluster, wherein the multiple add-ons include a first add-on associated with multiple first configuration fields and a second add-on associated with multiple second configuration fields;
generating one or more user interfaces based on the cluster add-on definition information to allow a user to request for a management action associated with at least one of the multiple cluster add-ons;
in response to receiving a first request for a first management action associated with the first add-on via a first user interface, generating and sending a first instruction to cause the first management action to be performed in the first cluster based on multiple first configuration values associated with the respective multiple first configuration fields; and
in response to receiving a second request for a second management action associated with the second add-on via a second user interface, generating and sending a second instruction to cause the second management action to be performed in the first cluster or the second cluster based on multiple second configuration values associated with the respective multiple second configuration fields.

9. The non-transitory computer-readable storage medium of claim 8, wherein generating the one or more user interfaces comprises:
generating the one or more user interface to allow the user to request at least one of the following management actions: (a) cluster creation and installation of one or more core add-ons specified by the cluster add-on definition information, (b) installation or uninstallation of a particular service add-on specified by the cluster add-on definition information, and (c) updating, upgrading or status monitoring for a particular add-on specified by the cluster add-on definition information.

10. The non-transitory computer-readable storage medium of claim 8, wherein generating and sending the first instruction comprises:
generating and sending the first instruction to perform the first management action in the form of creating the first cluster and installing the first add-on in the first cluster, wherein the first add-on is a core add-on and the first cluster is either a management cluster or a workload cluster.

11. The non-transitory computer-readable storage medium of claim 10, wherein generating and sending the first instruction comprises:
generating and sending the first instruction to perform the first management action in the form of updating or upgrading the first add-on in the first cluster, wherein the first cluster is either a management cluster or a workload cluster.

12. The non-transitory computer-readable storage medium of claim 8, wherein generating and sending the second instruction comprises:
generating and sending the second instruction to perform the management action in the form of installing, updating or upgrading the second add-on in the second cluster, wherein the second add-on is a service add-on and the second cluster is either a management cluster or a workload cluster.

13. The non-transitory computer-readable storage medium of claim 12, wherein providing the one or more user interfaces comprises:
identifying, from the cluster add-on definition information, configuration schema information specifying the multiple second configuration fields associated with the second add-on; and
generating a particular user interface that includes multiple user interface elements to allow an input of the multiple second configuration values associated with the respective multiple second configuration fields.

14. The non-transitory computer-readable storage medium of claim 8, wherein generating and sending the first or second instruction comprises:
generating and sending the first instruction or second instruction to a control plane (CP) entity that is capable of instructing a cluster operator to perform the first management action or second management action.

15. A computer system, comprising:
a processor; and
a non-transitory computer-readable medium having stored thereon instructions that, when executed by the processor, cause the processor to perform the following:
obtain cluster add-on definition information specifying multiple add-ons that are each capable of extending functionality of at least a first cluster and a second cluster, wherein the multiple add-ons include a first add-on associated with multiple first configuration fields and a second add-on associated with multiple second configuration fields;
generate one or more user interfaces based on the cluster add-on definition information to allow a user to request for a management action associated with at least one of the multiple cluster add-ons;
in response to receiving a first request for a first management action associated with the first add-on via a first user interface, generate and send a first instruction to cause the first management action to be performed in the first cluster based on multiple first configuration values associated with the respective multiple first configuration fields; and
in response to receiving a second request for a second management action associated with the second add-on via a second user interface, generate and send a second instruction to cause the second management action to be performed in the first cluster or the second cluster based on multiple second configuration values associated with the respective multiple second configuration fields.

16. The computer system of claim 15, wherein the instructions for generating the one or more user interfaces cause the processor to:
generate the one or more user interface to allow the user to request at least one of the following management actions: (a) cluster creation and installation of one or more core add-ons specified by the cluster add-on definition information, (b) installation or uninstallation of a particular service add-on specified by the cluster add-on definition information, and (c) updating, upgrading or status monitoring for a particular add-on specified by the cluster add-on definition information.

17. The computer system of claim 15, wherein the instructions for generating and sending the first instruction cause the processor to:
generate and send the first instruction to perform the first management action in the form of creating the first cluster and installing the first add-on in the first cluster, wherein the first add-on is a core add-on and the first cluster is either a management cluster or a workload cluster.

18. The computer system of claim 17, wherein the instructions for generating and sending the first instruction cause the processor to:
generate and send the first instruction to perform the first management action in the form of updating or upgrading the first add-on in the first cluster, wherein the first cluster is either a management cluster or a workload cluster.

19. The computer system of claim 15, wherein the instructions for generating and sending the second instruction cause the processor to:
generate and send the second instruction to perform the management action in the form of installing, updating or upgrading the second add-on in the second cluster, wherein the second add-on is a service add-on and the second cluster is either a management cluster or a workload cluster.

20. The computer system of claim 19, wherein the instructions for wherein providing the one or more user interfaces cause the processor to:
identify, from the cluster add-on definition information, configuration schema information specifying the multiple second configuration fields associated with the second add-on; and
generate a particular user interface that includes multiple user interface elements to allow an input of the multiple second configuration values associated with the respective multiple second configuration fields.

21. The computer system of claim 15, wherein the instructions for generating and sending the first or second instruction cause the processor to:
generate and send the first instruction or second instruction to a control plane (CP) entity that is capable of instructing a cluster operator to perform the first management action or second management action.
